(19) United States
(12) Patent Application Publication
(10) Pub. No.: US 2018/0195939 A1
(43) Pub. Date: Jul. 12, 2018

(54) GROUT SPECIMEN CAPPING SYSTEM

(71) Applicant: Deslauriers, Inc., LaGrange Park, IL (US)

(72) Inventors: Gary Workman, Las Vegas, NV (US); Thor Moody, Wesley Chapel, FL (US)

(21) Appl. No.: 15/400,434

(22) Filed: Jan. 6, 2017

(51) Int. Cl. G01N 3/04; G01N 3/08; E02D 33/00

(52) U.S. Cl. CPC G01N 3/04; E02D 33/00; G01N 3/08

(57) ABSTRACT

A grout capping system is disclosed for capping a grout specimen in the form of a rectangular prism. The system comprises an alignment fixture having a base, an alignment plate and a spacer securing the alignment plate to the base. The alignment plate is vertically spaced from the base and has a notch forming a right angle inside corner adapted to receive a corner of a grout specimen. A capping plate comprises a body having a square recess of a size to receive the grout specimen. The capping plate is receivable on the base with a corner of the recess aligned with the alignment plate notch so that a grout specimen received in the recess maintains perpendicularity with the capping plate.

### BACKGROUND OF THE INVENTION

### Field of the Invention

This invention relates to compression testing of grout samples and, more particularly, to a grout specimen capping system.

### Background of the Invention

Grout is a material used in reinforced masonry construction. Particularly, grout is placed in the cells of hollow concrete masonry units, sometimes referred to as cinder blocks. The grout must be fluid so that it completely fills the cells to provide a solid, grouted masonry wall. To satisfy these requirements, the grout is more fluid than concrete or mortar. Particularly, concrete typically has a slump in the range of 2 inches to 6 inches. Mortar typically has a slump in the range of 5 inches to 8 inches. Grout typically has a slump in the range of 8 inches to 10 inches. This fluidity allows the grout to flow through the grout space, around reinforcing bars and completely surround and bond to steel and concrete masonry units.

Presently, grout samples are tested in compression as a verification of strength. The traditional method for forming three grout samples for testing is to configure twelve concrete masonry units to form three chambers in the form of rectangular prisms. The chambers are lined with filter paper or other paper product. The chambers are filled with grout which is allowed to harden. An alternative procedure for forming grout samples is a box made of corrugated cardboard. The box includes a divider that divides the box into four rectangular compartments. Each compartment is filled with grout which then hardens to form samples in the form of rectangular prisms. Particularly, each sample has generally square-shaped end walls. As is apparent, the size of the overall sample and each wall is dependent on the apparatus used for forming the grout sample.

ASTM's Standard 01019 defines a standard test method for sampling and testing of grout. This includes the requirement that the specimens be square in cross section with a width between 3 and 3.75 inches and a height of about two times the width. The test specimen should be square on the ends, with sides planar and perpendicular to the top and bottom.

Compression tests of the grout specimens are performed by placing the specimen between platens of a testing apparatus and the specimen compressed until it fails. The platens are planar. Imperfections in the end walls can create pressure points that distort the compression test results. Current procedures require the grout specimen ends to be capped with a sulfur compound to provide a smooth, hard surface which fills any imperfections which normally occur when making grout specimens. Capping the grout specimen using sulfur compound requires the sulfur to be heated, poured into a capping fixture, placed onto the grout specimen and allowed to cool.

The known capping systems are designed for testing 6″ diameter concrete specimens in the form of cylinders. Also, the known capping systems are designed for cylindrical specimens that are 12″ long. Since grout specimens are typically 3¼″ to 3½″ square and 6-7″ tall the use of a 6″ diameter capping system is a difficult process. First, since the specimen must be in the center of the capping plate, labs can only perform visual placement. Second, since there is no vertical guide, labs must use a level to determine perpendicularity.

The present invention is directed to further improvements in grout specimen compression testing.

### SUMMARY OF THE INVENTION

The disclosed grout specimen capping system uses an alignment fixture and capping plate allowing for straightforward capping of the grout specimen which is in the form of a rectangular prism.

There is disclosed herein a grout capping system for capping a grout specimen in the form of a rectangular prism. The system comprises an alignment fixture having a base, an alignment plate and a spacer securing the alignment plate to the base. The alignment plate is vertically spaced from the base and has a notch forming a right angle inside corner adapted to receive a corner of a grout specimen. A capping plate comprises a body having a square recess of a size to receive a capping material and the grout specimen. The capping plate is receivable on the base with a corner of the recess aligned with the alignment plate notch so that a grout specimen received in the recess maintains perpendicularity with the capping plate.

It is a feature that the square recess is beveled around its periphery.

It is a feature that a bottom wall of the square recess has sides of about 3.5 to 3.625 inches.

It is another feature that the capping plate is of steel.

It is a further feature that the capping plate is about 1 inch thick.

It is an additional feature that the alignment fixture is of steel construction.

It is still another feature that the spacer comprises an L shaped bracket.

It is also a feature that the alignment fixture comprises a second alignment plate and a second spacer securing the second alignment plate to the first alignment plate. The second alignment plate is vertically spaced from the first alignment plate and has a notch forming a right angle inside corner aligned with the notch of the first alignment plate.

It is yet a further feature that the alignment plate has a circular opening at the inside corner of the notch.

There is also disclosed herein a method of capping a grout specimen in the form of a rectangular prism, comprising: providing an alignment fixture having a base, an alignment plate and a spacer securing the alignment plate to the base, the alignment plate being vertically spaced from the base, the alignment plate having a notch forming a right angle inside corner; providing a capping plate comprising a body having a square recess of less than ½ inch depth of a size to receive the grout specimen; preheating and oiling the capping plate and positioning the capping plate on the base with a grout specimen centered in the recess; moving the capping plate so that the grout specimen is received in the notch; removing the grout specimen from the capping plate; filling the recess with a capping compound and returning the grout specimen to the recess held against the alignment plate, in the notch, to maintain perpendicularity of the grout specimen; and removing the capped grout specimen from the capping plate.

Further features and advantages will be apparent from the specification and from the drawings.

### BRIEF DESCRIPTION OF THE DRAWINGS

FIG. 1 is a perspective of a grout specimen capping system in accordance with the invention;

FIG. 2 is a perspective of an alignment fixture of the grout specimen capping system of FIG. 1;

FIG. 3 is a plan view of the grout specimen capping system of FIG. 1;

FIG. 4 is an elevation view of the grout specimen capping system of FIG. 1;

FIG. 5 is a perspective view of a capping plate of the grout specimen capping system of FIG. 1;

FIG. 6 is a perspective view the grout specimen capping system with a grout specimen used to align the capping plate on the alignment fixture;

FIG. 7 is a perspective view, similar to FIG. 6, with a capping compound in the capping plate; and

FIG. 8 is a perspective view of a grout specimen capped using the grout specimen capping system of FIG. 1.

### DETAILED DESCRIPTION OF THE INVENTION

ASTM's Standard C1019 defines a standard test method for sampling and testing of grout. This includes the requirement that the specimens be square in cross section with a width between 3 and 3.75 inches and a height of about two times the width. The test specimen should be square on the ends, with sides planar and perpendicular to the top and bottom. This shape is referred to herein as a rectangular prism.

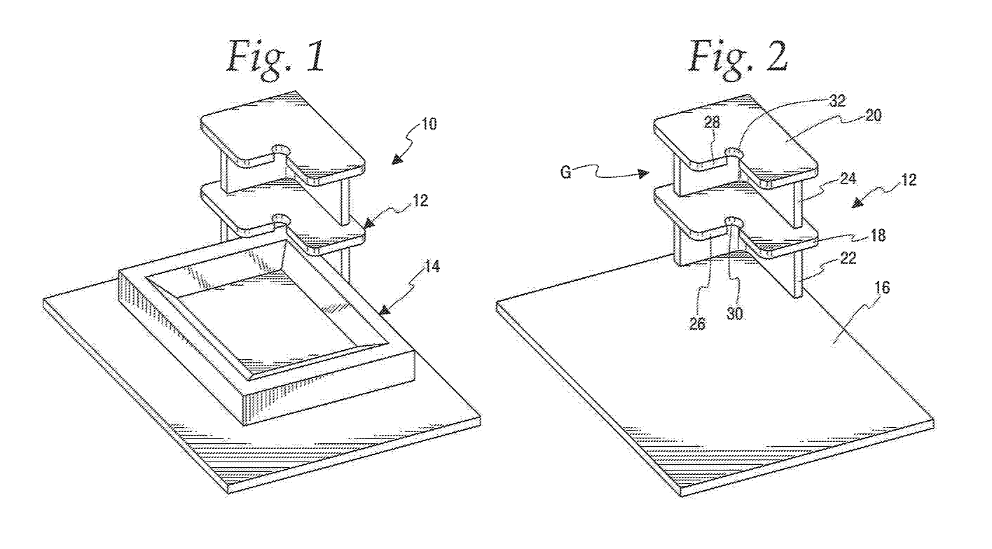

This application is directed to a grout capping system 10, see FIG. 1, for capping a grout specimen S, see FIG. 6, in the form of a rectangular prism. The system 10 comprises an alignment fixture 12 and a capping plate 14.

The grout capping system 10 is used for grout specimens to be strength tested and usually sulfur capped to meet ASTM C617 for capping cylindrical concrete specimens.

The alignment fixture 12, see FIGS. 2 and 4, comprises a base 16, a first alignment plate 18, a second alignment plate 20 and spacers 22 and 24. In the illustrated embodiment the alignment fixture 12 is made of A36 carbon steel with a black oxidized finish. Other materials could be used, as is apparent.

The base is about 8.5″ square. The alignment plates 18 and 20 are about 3.35″ square with a respective notch 26 and 28 forming a right angle inside corner adapted to receive a corner of a grout specimen S. A circular opening 30 and 32, respectively, is at the inside corner of each notch 26 and 28. The spacers 22 and 24 are L-shaped. The first spacer 22 is secured, such as by welding, to a corner of the base 16 and the underside of the first alignment plate 18. The second spacer 24 is secured to an upper side of the first alignment plate 18 and to the underside of the second alignment plate 20. The spacers 22 and 24 maintain the alignment plates 18 and 20 parallel with the base 16, with the respective notches 26 and 28 aligned. The first alignment plate is about 2.25″ above the base 16. The second alignment plate 20 is about 2.25″ above the first alignment plate 18. As is apparent, different dimensions could be used and are dependent on the size of specimens to be capped. Also, a different number of alignment plates could be used.

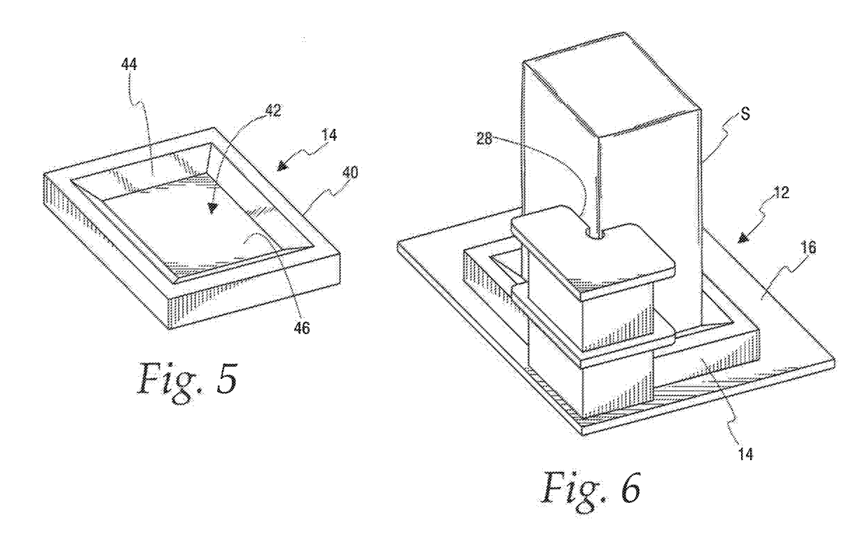

The capping plate 14, see FIG. 5, comprises a body 40 of 4150 alloy steel with a black oxide finish. As will be apparent, other materials could also be used. The body 40 is about 5″ square and about 1″ thick. The top of the body 40 has a square recess 42 of less than ½″ depth of a size to receive a grout specimen S. The recess 42 is formed by a beveled side wall 44 terminating at a bottom wall 46. The bottom wall 46 is in a range of about 3.5″ to 3.625″ square. The recess 42 is sized to accommodate prism samples that are cast in both a sample box which yields prism samples that are 3.125″×3.125″×6.250″ tall and the traditional pinwheel method which yields samples that are 3.5″×3.5″×7″ tall. The other dimensions are made for manufacturing cost considerations. The recess 42 allows the prism to be easily placed within 1/16″ of the center of the bottom wall 46 to meet the requirements of ASTM C617.

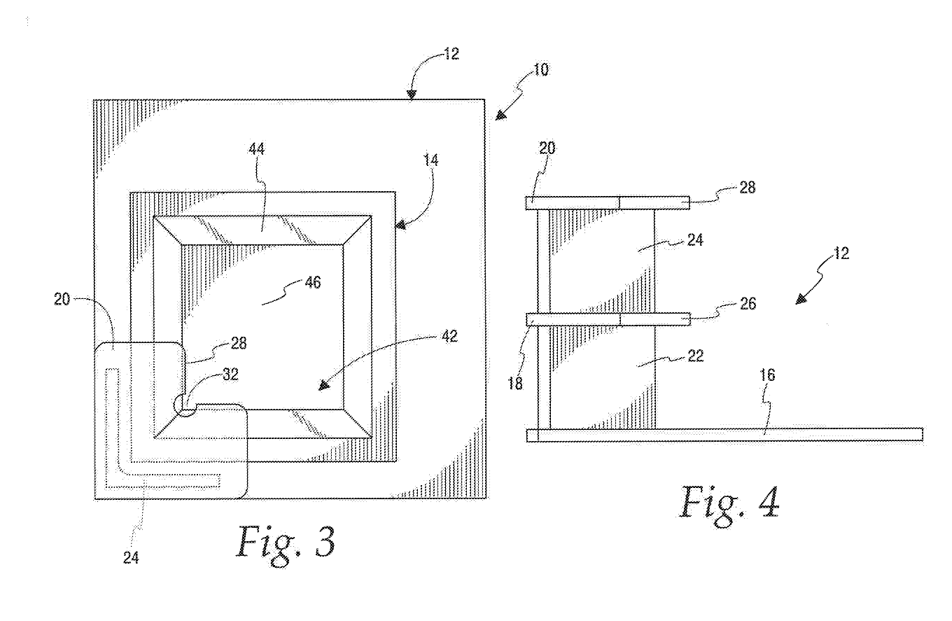

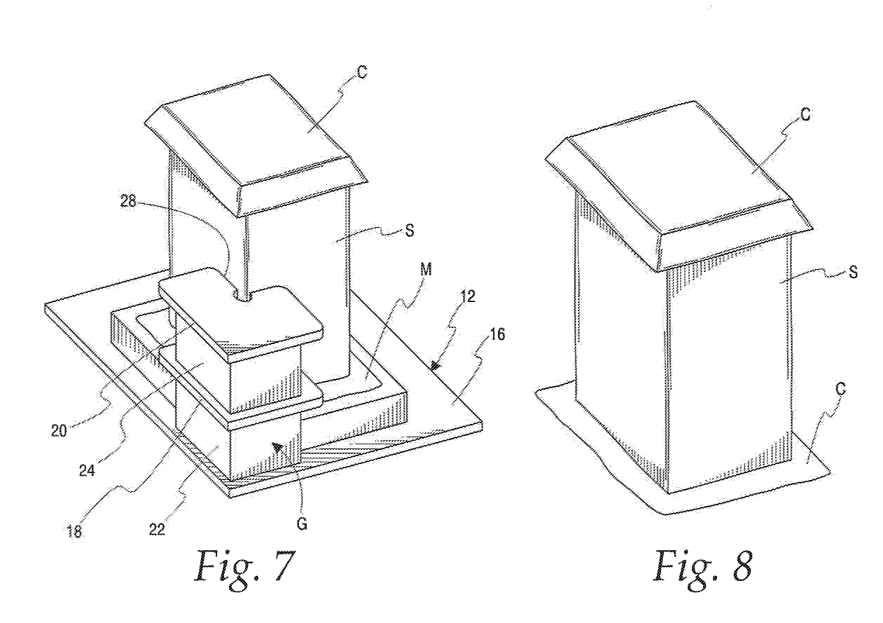

The methodology for using the system 10 for capping is now described. The capping plate 14 is preheated to guard against rapid cooling of capping material. The capping plate 14 and the recess 42 are lightly oiled to facilitate removal of capped specimens. This is repeated for each use. A specimen S to be capped is placed on protective paper towel or cloth in the capping recess 42 and the specimen S is carefully centered. Keeping the specimen S centered, the capping plate 14 is moved so that the specimen S is received against vertical guide G formed by the notches 26 and 28, see FIG. 6. This positions the capping plate 14 so that the specimen S will maintain perpendicularity and be centered in the recess 42 during capping. Next, remove the specimen S and protective paper or cloth from the capping plate 14, being careful not to move the plate 14. The position of the capping plate 14 relative to the fixture 12 is shown in FIG. 3. A molten capping material M, such as sulfur, is placed in the capping recess 42, and the specimen S is immediately lowered into the capping recess 42 while holding the specimen S against the vertical guide G, see FIG. 7. The specimen S is held against the vertical guide G until the capping material has sufficiently cooled so that the specimen S will remain vertically aligned when released. After allowing the cap to cool, the capped specimen S is removed from the capping plate 14 by gently prying against the vertical guide G. This process is repeated to cap the opposite end of the specimen S resulting in the specimen S with opposite caps C as shown in FIG. 8.

The capping plate 14 and recess 42 are designed to meet ASTM C0617 (Practice for Capping Cylindrical Concrete Specimens) for hardness, thickness and depth. The capping recess 42 is also designed to conform to the square geometry of grout prisms cast in accordance with ASTM C1019 (Standard Method for Sampling and Testing Grout). The vertical capping guide G helps ensure that the specimens S remain perpendicular during the capping procedure. There is no need to use a level, or seat specimens by eye, as in the past. The beveled wall 44 of the recess 42 is designed to promote easy removal of capped specimens S.

As described, the system 10 can be used to implement a method of capping a grout specimen S in the form of a rectangular prism, comprising: providing an alignment fixture 12 having a base 16, an alignment plate(s) 18 and/or 20, and a spacer(s) 22 and/or 24, securing the alignment plate(s) to the base, the alignment plate(s) being vertically spaced from the base 16, the alignment plate(s) having a notch 26 and/or 28 forming a right angle inside corner; providing a capping plate 14 comprising a body 40 having a square recess 42 of less than ½ inch depth of a size to receive the grout specimen; preheating and oiling the capping plate 14 and positioning the capping plate 14 on the base 16 with a grout specimen S centered in the recess 42; moving the capping plate 14 so that the grout specimen S is received in the notch; removing the grout specimen S from the capping plate 14; filling the recess 42 with a capping compound M and returning the grout specimen S to the recess 42 held against the alignment plate 18 and/or 20, in the notch, to maintain perpendicularity of the grout specimen S; and removing the capped grout specimen from the capping plate 14.

It will be appreciated by those skilled in the art that there are many possible modifications to be made to the specific forms of the features and components of the disclosed embodiment while keeping within the spirit of the concepts disclosed herein. Accordingly, no limitations to the specific forms of the embodiments disclosed herein should be read into the claims unless expressly recited in the claims. Although a few embodiments have been described in detail above, other modifications are possible. Other method steps may be provided, or steps may be eliminated, from the described methodology, and other components may be added to, or removed from, the described systems. Other embodiments may be within the scope of the following claims.

The foregoing disclosure of specific embodiments is intended to be illustrative of the broad concepts comprehended by the invention.

1. A grout capping system for capping a grout specimen in the form of a rectangular prism, comprising:
an alignment fixture having a base, an alignment plate and a spacer securing the alignment plate to the base, the alignment plate being vertically spaced from the base, the alignment plate having a notch forming a right angle inside corner adapted to receive a corner of a grout specimen, in use; and
a capping plate comprising a body having a square recess of a size to receive the grout specimen, the capping plate being receivable on the base with a corner of the recess aligned with the alignment plate notch so that a grout specimen received in the recess maintains perpendicularity with the capping plate.

2. The grout capping system of claim 1 wherein the square recess is beveled around its periphery.

3. The grout capping system of claim 1 wherein a bottom wall of the square recess has sides of about 3.5 to 3.625 inches.

4. The grout capping system of claim 1 wherein the capping plate is of steel.

5. The grout capping system of claim 1 wherein the capping plate is about 1 inch thick.

6. The grout capping system of claim 1 wherein the alignment fixture is of steel construction.

7. The grout capping system of claim 1 wherein the spacer comprises an L shaped bracket.

8. The grout capping system of claim 1 wherein the alignment fixture comprises a second alignment plate and a second spacer securing the second alignment plate to the first alignment plate, the second alignment plate being vertically spaced from the first alignment plate, the second alignment plate having a notch forming a right angle inside corner aligned with the notch of the first alignment plate.

9. The grout capping system of claim 1 wherein the alignment plate has a circular opening at the inside corner of the notch.

10. A method of capping a grout specimen in the form of a rectangular prism, comprising:
providing an alignment fixture having a base, an alignment plate and a spacer securing the alignment plate to the base, the alignment plate being vertically spaced from the base, the alignment plate having a notch forming a right angle inside corner;
providing a capping plate comprising a body having a square recess of less than ½ inch depth of a size to receive the grout specimen;
preheating and oiling the capping plate and positioning the capping plate on the base with a grout specimen centered in the recess;
moving the capping plate so that the grout specimen is received in the notch;
removing the grout specimen from the capping plate;
filling the recess with a capping compound and returning the grout specimen to the recess held against the alignment plate, in the notch, to maintain perpendicularity of the grout specimen; and
removing the capped grout specimen from the capping plate.

11. The method of capping a grout specimen of claim 10 wherein the square recess is beveled around its periphery to promote removal of the grout specimen.

12. The method of capping a grout specimen of claim 10 wherein a bottom wall of the square recess has sides of about 3.5 to 3.625 inches.

13. The method of capping a grout specimen of claim 10 wherein the capping plate is of steel.

14. The method of capping a grout specimen of claim 10 wherein the capping plate is about 1 inch thick.

15. The method of capping a grout specimen of claim 10 wherein the alignment fixture is of steel construction.

16. The method of capping a grout specimen of claim 10 wherein the spacer comprises an L shaped bracket.

17. The method of capping a grout specimen of claim 10 wherein providing the alignment fixture comprises providing a second alignment plate and a second spacer securing the second alignment plate to the first alignment plate, the second alignment plate being vertically spaced from the first alignment plate, the second alignment plate having a notch forming a right angle inside corner aligned with the notch of the first alignment plate.

18. The method of capping a grout specimen of claim 10 wherein the alignment plate has a circular opening at the inside corner of the notch.
